(19) United States
(12) Patent Application Publication
(10) Pub. No.: US 2025/0256592 A1
(43) Pub. Date: Aug. 14, 2025

(54) METHOD AND SYSTEM FOR AUTOMATIC ELECTRICAL CONNECTION BETWEEN TWO CONNECTORS

(71) Applicant: GULPLUG, Grenoble (FR)

(72) Inventors: Ronan Troufflard, Grenoble (FR); Antoine Le Faucheux, Grenoble (FR)

(21) Appl. No.: 18/867,036

(22) PCT Filed: May 17, 2023
(86) PCT No.: PCT/EP2023/063354

§ 371 Date: Nov. 19, 2024

(30) Foreign Application Priority Data
May 19, 2022 (FR) FR2204786

(51) Int. Cl. B60L 53/16; B60L 53/36; B60L 53/66; H01R 13/62; H01R 43/26

(52) U.S. Cl. CPC B60L 53/16; B60L 53/36; B60L 53/66; H01R 13/6205; H01R 43/26

(57) ABSTRACT

The invention relates to a method for automatic electrical connection, implemented in order to carry out wired charging of a rechargeable electric or hybrid vehicle, between a plug connected to an electrical power supply assembly of the electric vehicle, and a socket connected to an electrical power supply network to which the power supply assembly of the electric vehicle has to connect in order to be charged, the plug being initially housed in a housing of a first connection unit (VU) located on the vehicle side and comprising a first control unit (UC_1), and the socket being carried by a second connection unit (GU) located on the electrical network side and comprising a second control unit (UC_2), the plug comprising a first magnetic architecture (AM_1) and the socket comprising a second magnetic architecture (AM_2), the plug and the socket being able to be coupled mechanically via a magnetic effect.

### TECHNICAL FIELD OF THE INVENTION

The present invention relates to a method and to a system for electrical connection between two connectors.

### PRIOR ART

Patent application WO2017/216458A1 discloses an electrical connection device that takes the form of a pedestal integrating a magnetically attractive electrical socket. The electrical socket is positioned centrally and the pedestal has a surface that skirts the front connection face of the electrical socket. The electrical socket is equipped with magnetic means allowing it to attract, via a magnetic effect, an electrical plug equipped with corresponding magnetic means. The electrical connection is made between the socket and the plug when the two elements are bonded via the magnetic effect. The plug is connected to an electrical apparatus, such as for example a power supply system of an electric vehicle. In one particular embodiment, the device comprises a plurality of annular coils that are integrated into the pedestal and positioned concentrically around the electrical socket. In operation, the pedestal integrating the electrical socket is for example placed on the ground and connected to the mains by an electrical cable. The plug is released from the apparatus in proximity to the pedestal. The coils are controlled using a control sequence designed to guide the plug toward the center of the pedestal and therefore toward the electrical socket. The connection is finalized via the magnetic attraction present between the respective magnetic means of the socket and plug.

This prior solution relates only to the principle for making the connection between the plug and the socket, in particular by virtue of the coils integrated into the pedestal placed on the ground. This prior document is not concerned with the steps prior to the connection between the plug and the socket, in particular those concerning the activation of each connection unit, on the vehicle side and on the electrical network side.

Patent application US2020/269714A1 describes a solution for charging an electric vehicle.

U.S. Pat. No. 10,090,885B2 describes a solution for inductively charging an electric vehicle. It provides in particular a method for alignment between the two antennas using magnetic fields.

U.S. Pat. No. 9,446,675B2 describes a solution for inductively charging an electric vehicle, using alignment means with receive antennas.

Patent application JP2013225969 describes an identification method implemented in a solution for inductively charging a vehicle.

Patent application WO2019/204377A1 describes an alignment system and method in a solution for inductively charging an electric vehicle.

The invention aims to propose an automatic electrical connection method that is able to integrate all of the steps necessary to ensure the wired connection between a plug located on the vehicle side and a socket located on the electrical network side.

### DESCRIPTION OF THE INVENTION

This aim is achieved by a method for automatic electrical connection, implemented in order to carry out wired charging of a rechargeable electric or hybrid vehicle, between a plug connected to an electrical power supply assembly of the electric vehicle, and a socket connected to an electrical power supply network to which the power supply assembly of the electric vehicle has to connect in order to be charged, the plug being initially housed in a housing of a first connection unit located on the vehicle side and comprising a first control unit, and the socket being carried by a second connection unit located on the electrical network side and comprising a second control unit, the plug comprising a first magnetic architecture and the socket comprising a second magnetic architecture, the plug and the socket being able to be coupled mechanically via a magnetic effect, said method comprising:
A step of the second connection unit generating a magnetic field using an electromagnetic coil,
A step of the first connection unit detecting said magnetic field generated by the second connection unit,
A step of automatically releasing the plug from the housing of the first connection unit after detection of the presence of said magnetic field, with a view to connecting it to the socket,
A step of launching an electrical connection sequence, the electrical connection sequence comprising steps carried out in order to attract the plug toward the socket, via a magnetic effect, by activating said electromagnetic coil, with a view to connecting the plug to the socket.

According to the invention, the electromagnetic coil is therefore used to detect the presence of the second connection unit by the first connection unit, and in the sequence of connecting the plug to the socket, to guide the plug toward the socket.

According to one particular feature, the method comprises a prior step of detecting the position of the vehicle with respect to the second connection unit and a step of activating the second control unit of the second connection unit when the vehicle is in a determined stationary position.

According to another particular feature, the method comprises a prior step of detecting the presence of the vehicle close to the second connection unit and a step of launching a sequence of guiding the vehicle so as to bring it into a determined position with respect to the second connection unit.

According to another particular feature, the method comprises a step of monitoring the speed of the vehicle and a step of activating detection means of the first connection unit, implemented taking into account said monitored speed.

According to another particular feature, the method comprises a step of pre-authentication between the first connection unit and the second connection unit, carried out by exchanging data via a wireless link between the two connection units, implemented prior to the step of launching the electrical connection sequence.

According to another particular feature, the method comprises a step of authentication by exchanging data via a wired link between the first connection unit and the second connection unit, when the plug is connected to the socket.

The invention also relates to an automatic electrical connection system used for wired charging of an electric or hybrid vehicle, comprising a plug connected to an electrical power supply assembly of the electric vehicle, and a socket connected to an electrical power supply network to which the power supply assembly of the electric vehicle has to connect in order to be charged, the system comprising a first connection unit comprising a housing in which the plug is initially housed, said first connection unit being located on the vehicle side and comprising a first control unit, and a second connection unit carrying the socket, located on the electrical network side and comprising a second control unit, the plug and the socket being able to be coupled mechanically via a magnetic effect, said system being characterized in that:
The second connection unit comprises means for generating a magnetic field using an electromagnetic coil, said means being able to be activated by the second control unit,
The first connection unit comprises first detection means for detecting said magnetic field generated by the second connection unit,
The first connection unit comprises release means for automatically releasing the plug from said housing of the first connection unit, said means being activated after detection of the presence of said magnetic field, in order to connect it to the socket,
The second control unit is configured to activate an electrical connection sequence, the electrical connection sequence comprising steps carried out in order to attract the plug toward the socket, via a magnetic effect, by activating said electromagnetic coil, with a view to connecting the plug to the socket.

According to one particular feature, the system comprises second detection means for detecting the presence of the vehicle close to the second connection unit and execution means for executing a sequence of guiding the vehicle so as to bring it into a determined position with respect to the second connection unit.

According to another particular feature, the system comprises monitoring means for monitoring the speed of the vehicle and the first control unit is configured to activate first detection means, taking into account said monitored speed.

According to another particular feature, the first control unit and the second control unit are configured to execute a pre-authentication sequence between the first connection unit and the second connection unit, by exchanging identification data via a wireless link between the two connection units, prior to the electrical connection between the plug and the socket.

According to another particular feature, the first control unit and the second control unit are configured to execute an authentication sequence between the first connection unit and the second connection unit, by exchanging identification data via a wired link between the two connection units, once the plug has been connected to the socket.

According to another particular feature, the electrical connection sequence is configured to activate electromagnetic means of the second connection unit, said electromagnetic means being designed to attract the plug toward the socket via a magnetic effect.

According to another particular feature, the second control unit is configured to activate said electromagnetic means of the second connection unit as means for generating the magnetic field.

According to another particular feature, the first detection means are arranged in the first connection unit in order to detect the presence of said magnetic field generated by the second connection unit and to discriminate its presence from that of a second magnetic field generated by the first magnetic architecture.

According to another particular feature, the system comprises second detection means for detecting the position of the vehicle with respect to the second connection unit and activation means for activating the second connection unit when the vehicle is in a determined stationary position.

According to another particular feature, the second connection unit is integrated into a mat in which said second detection means are also integrated.

According to another particular feature, the system comprises at least one chock fixed to said mat, said chock integrating at least one position sensor of said second detection means.

According to another particular feature, the system comprises at least one stop device fixed to said mat, at least one position sensor of said second detection means being integrated into said mat, close to said stop device.

### BRIEF DESCRIPTION OF THE FIGURES

Other features and advantages will become apparent in the following detailed description given with reference to the appended drawings, in which:

FIG. 1 schematically shows the connection system according to the invention;

FIG. 2 shows the functional architecture of the connection system according to the invention;

FIGS. 3A to 3D show various variant embodiments of the second part of the connection system of the invention;

FIG. 4 shows a diagram showing the various steps implemented during the method for connection between the plug and the socket, according to the invention;

FIGS. 5A to 5L schematically illustrate the various steps implemented during the method for connection between the plug and the socket, according to the invention;

FIG. 6 illustrates one particular feature of the connection system of the invention;

FIG. 7 shows, in a non-limiting manner, one exemplary embodiment of the two magnetic architectures distributed in the plug and in the socket of the connection system of the invention.

### DETAILED DESCRIPTION OF AT LEAST ONE EMBODIMENT

The invention is generally applicable to an electrical connection system, which may in particular be employed in an electrical installation intended for charging an electric vehicle.

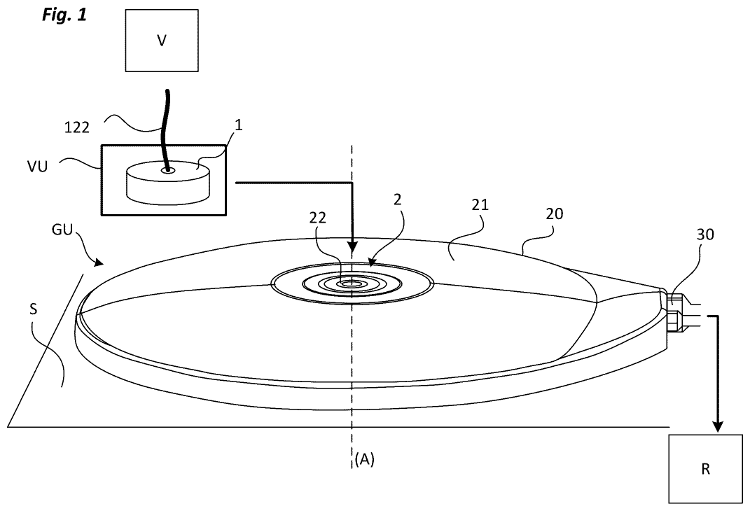

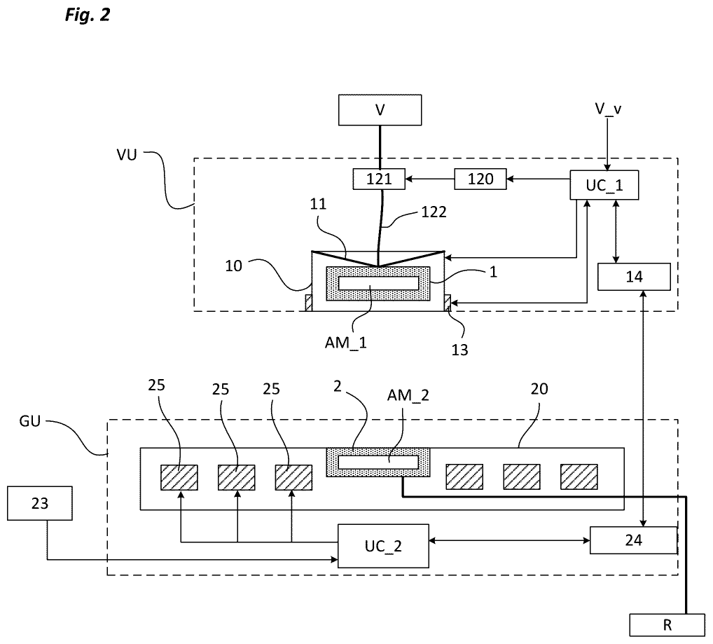

With reference to FIG. 1, the system is made up of two parts, one of the two parts being intended to be connected to an electrical power supply network R, and the other part being intended to be connected to a power supply assembly of a rechargeable electric or hybrid vehicle V.

Any solution allowing electrical connection to the electrical power supply assembly of the vehicle V or to the electrical power supply network R may be envisioned, such as a cable, conductive rod, or some other equivalent solution, etc.

The first part of the system comprises a first connection unit VU located on the vehicle V side and carrying an electrical plug 1, and the second part comprises a second connection unit GU, located on the electrical power supply network R side and carrying an electrical socket 2 to which the plug 1 is intended to be connected.

The system advantageously allows the plug 1 to be mechanically connected to the socket 2 automatically, without the intervention of an operator or robot, solely using magnetic and gravitational means.

Of course, the terms “plug” and “socket” should be understood in a non-limiting manner, without any a priori regarding their respective structures, and it should be understood that they are precise terms for defining a first connector and a second connector, intended to be connected mechanically and electrically to one another.

An assembly direction, corresponding to a principal axis (A) along which the plug 1 is brought to bear mechanically against the socket 2, is defined here and will be referred to in the remainder of the description.

In the remainder of the description, the terms “front” and “rear” and “high” and “low” and “higher” and “lower” are to be considered with reference to longitudinal position along the principal axis (A).

In the remainder of the description, the terms “inside” and “outside” are to be considered with reference to coaxial position with respect to the principal axis (A).

When the plug 1 is connected to the socket 2, the front part of the plug 1 comes to bear mechanically against the front part of the socket 2 and an electrical connection may then be made.

A connection between the plug and the socket is understood to mean that the plug is in mechanical contact against the socket and that one or more electrical connection members of the plug are electrically connected to one or more electrical connection members of the socket.

With reference to FIG. 1, the plug 1 and the socket 2 are intended to be connected via a magnetic effect.

The socket 2 is equipped with a magnetic architecture AM_2 arranged transversely to the principal axis (A), allowing it to attract the plug 1, which for its part is equipped with a corresponding magnetic architecture AM_1. When the plug 1 is bonded via a magnetic effect to the socket 2, an electrical connection is also made between the first electrical connection members of the socket 2 and second electrical connection members of the plug 1.

The two magnetic architectures used make it possible to ensure bonding of the plug 1 to the socket 2 via a magnetic effect. Various magnetic architectures, allowing the plug 1 to be bonded to the socket 2, are described in particular in patent EP3317926B1 and in patent application WO2020/229321A1. These are applicable to the present invention but are to be considered non-limiting. The two magnetic architectures advantageously comprise a plurality of permanent magnets. According to one particular feature, when the plug is in a suitable angular position with respect to the socket, the two magnetic architectures act attractively to make the connection, or repulsively when the plug must be withdrawn from the socket during disconnection.

By way of example, FIG. 7 shows the magnetic architecture AM_2 present on the socket 2 side and the magnetic architecture AM_1 present on the plug 1 side. The two magnetic architectures shown comprise a ferromagnetic yoke 110, 210 and one or more permanent-magnet portions fixed to said yoke.

In the second magnetic architecture, three permanent magnets 211 of a first set each extend for example over an angular range AP1 of 55° on their annular portion and three permanent magnets 212 of a second set extend for example over an angular range AP2 of 55°.

Each of the three permanent magnets of the second set is interposed between two permanent magnets of the first set, leaving a regular non-zero angular interval between these two magnets of the first set. The regular angular interval 11 between two adjacent magnets is about 5°.

The permanent magnets of the first set and those of the second set are magnetically oriented along the principal axis (A) and in opposite directions.

The first magnetic architecture AM_1 has only a first set of three permanent magnets 111, which are identical to the permanent magnets of the first magnetic architecture.

It should be noted that the two magnetic architectures AM_1, AM_2 are configured to ensure bonding of the plug 1 against the socket 2, via an attractive magnetic effect, with a given orientation about the principal axis. The two magnetic architectures AM_1, AM_2 are configured so that the plug 1 may assume a plurality of distinct angular positions when it is bonded to the socket 2 via a magnetic effect.

For example, with the magnetic architectures shown in FIG. 7, the plug 1 may assume three distinct angular positions that are offset from one another by 120°. The plug 1 may be in a first angular position, called the 0° position, a second angular position, called the −120° position, or in a third angular position, called the +120° position.

Of course, the magnetic arrangements (angular ranges of the magnets and angular intervals between magnets) of the magnetic architecture may be adjusted.

The first connection unit VU comprises a housing 10 in which the plug 1 is housed. This housing 10 may be designed so as to cover and protect the connection members of the plug 1 when the plug is housed therein. The first connection unit VU may comprise extraction means 11 for extracting the plug 1 from the housing, as well as release means for releasing the plug 1 from the housing 10. These release means for releasing the plug 1 may consist of an electric motor 120 for driving a winder 121 or other equivalent means, making it possible to wind up or unwind an electric cable 122 to the end of which the plug 1 is connected.

The first connection unit VU also comprises first magnetic field detection means 13 associated with the first connection unit VU. These first detection means 13 may comprise one or more sensors, such as Hall sensors for example.

The first connection unit VU may also comprise first communication means 14 used to exchange data, in particular identification data, with the second connection unit GU. These first communication means 14 may comprise a wireless communication interface and a wired communication interface.

The first connection unit VU also comprises a first control unit UC_1 that is responsible for managing in particular:
The monitoring of a parameter of the vehicle, for example its speed V_v, with a view to activating or deactivating the first detection means 13 and therefore waking up the first connection unit VU;
The management of the data received from the first detection means 13, after they have been activated, with a view to detecting the presence of the second connection unit GU nearby;
The management of the first communication means 14, with a view to controlling the exchange of identification data, via the wireless communication interface, with the second connection unit GU when the latter is detected nearby and the connection between the plug 1 and the socket 2 is not yet made;
The extraction of the plug 1, by controlling the extraction means 11 for extracting the plug 1 from the housing 10 and the release means for releasing the plug 1 when the first connection unit and the second connection unit are pre-authenticated;
The management of the first communication means 14, with a view to controlling the exchange of data, via the wired communication interface, with the second connection unit GU, once the connection between the plug 1 and the socket 2 has been made.

According to one particular aspect, the first control unit UC_1 is for example able to activate or deactivate the first detection means 13 taking into account the variation of at least one parameter. This may be for example the speed of the vehicle. Below a speed threshold value (taking into account a hysteresis), the first control unit UC_1 may activate the first detection means 13 in order to wake them up and start them monitoring for the presence of a sufficiently intense surrounding magnetic field.

The second connection unit GU integrates the socket 2. In a non-limiting manner, this second connection unit GU advantageously has a pedestal 20 to be placed on a support (for example the ground S—the principal axis (A) is then orthogonal to the ground). The pedestal 20 may comprise one or more connectors 30 allowing it to be connected to the electrical network R and possibly to an external communication system. Electrical connections integrated into the pedestal 20 allow the electrical socket 2 to be connected to said connectors 30.

With reference to FIG. 1, the pedestal 20 comprises a closed jacket 21, part of which, for example the central part, is occupied by the socket 2.

The electrical socket 2 comprises a front land 22 via which it is mechanically connected with the plug 1. This front land 22 is oriented transversely to the principal axis (A) and may be of any suitable shape, planar or curved, concave or convex. The jacket 21 skirts the socket 2 and defines a front surface that skirts the front land 22 of said socket 2. This front surface lies beyond the front land 22 of the socket 2 and is not dedicated to connection. The front surface of the pedestal 20, around the socket 2, may be planar in the same plane as that formed by the front land 22 of the socket 2, or of a concave or convex curved shape (as in the appended figures). Under this surface, the jacket 21 of the second connection unit GU integrates magnetic guidance means designed to guide the plug 1 toward the socket 2 as the plug 1 approaches. In an non-limiting manner, patent application No. WO2017/216458A1 describes an operating principle whereby the plug 1 is connected to the socket 2 by executing a sequence of controlling magnetic guidance means integrated into the jacket.

The magnetic guidance means advantageously comprise a plurality of electromagnetic coils, called guide coils 25, housed in the jacket of the pedestal 20, and arranged concentrically around the socket 2. The control sequence may consist in activating one or more of the guide coils 25, so as to bring the plug 1 as close as possible to the socket 2, by acting on the magnetic architecture AM_1 of the plug 1 via a magnetic effect. Once the plug 1 has been brought close to the axis of the socket 2, the two magnetic architectures AM_1, AM_2, located on the plug 1 side and on the socket 2 side, make it possible to finalize the connection between the two elements.

The second part of the system also comprises second detection means 23 for detecting the position of the vehicle, associated with the second connection unit GU. These second detection means 23 may comprise at least one presence sensor and/or at least one position sensor. These second detection means 23 are used by the second connection unit GU to ensure that the vehicle V is in a determined position, in order to determine whether a connection sequence with the plug 1 is able to be started. It will be seen below that these second detection means 23 may be integrated into various architectures associated with the second connection unit GU.

The second connection unit GU may also comprise second communication means 24 used to exchange data, in particular identification data, with the first connection unit VU. These second communication means 24 may comprise a wireless communication interface and a wired communication interface.

The second connection unit GU comprises a second control unit UC_2 configured to:
Receive the data from the second detection means 23 and process them with a view to determining whether the vehicle V is in a determined position;
Activate at least one guide coil 25 of the magnetic guidance means, in order to generate a magnetic field able to be detected by the first detection means 13 of the first connection unit VU; this action is executed for example when the presence of the vehicle V or the position of the vehicle is detected by the second detection means 23;
Manage its second communication means 24, with a view to controlling the exchange of identification data, via the wireless communication interface, with the first connection unit VU when the latter is detected nearby and the connection between the plug 1 and the socket 2 is not yet made;
Launch the sequence of connecting the plug 1 to the socket 2, when the presence of the plug 1 is detected near the second connection unit GU; the connection sequence comprises the sequence of controlling the guide coils used to attract the plug 1 toward the socket 2;
Manage its second communication means 24, with a view to controlling the exchange of data, via the wired communication interface, with the first connection unit VU, once the connection between the plug 1 and the socket 2 has been made.

On the side of the second connection unit GU, the second detection means 23 may be implemented in line with various solutions defined below and integrated in line with various support architectures. For each of these solutions, the second control unit UC_2 is configured to generate a magnetic field able to be detected by the first connection unit VU, when the presence and/or the position of the vehicle V is detected.

For these various solutions, it should be noted that the second part of the system, integrating the second connection unit GU, the second detection means 23 and the support architecture of the second detection means 23, may be implemented in the form of a single-piece assembly, housing the wiring and the means necessary for the second part of the system to operate. Advantageously, this assembly may be in the form of a mat placed on the ground, on which the vehicle V is able to park, the mat T being produced in one piece. It should be noted that this single-piece assembly, for example the mat, may have visual means, such as colored strips or the like able to assist the driver with positioning the vehicle correctly so that the connection between the plug 1 and the socket 2 is able to be made.

It will be seen below that each chock or stop device may be joined to and integrated into the mat T. The position or presence sensors are integrated into the mat, at the chock, close to the stop device or in the body of the mat T. The mat T thus forms a single-piece assembly that is able to be deployed easily and that integrates all the elements necessary for the second part of the connection system of the invention to operate.

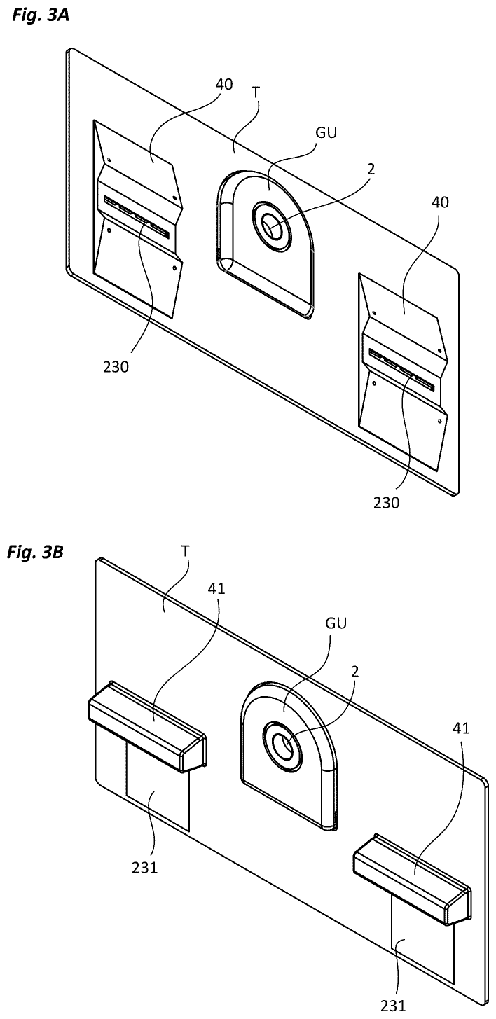

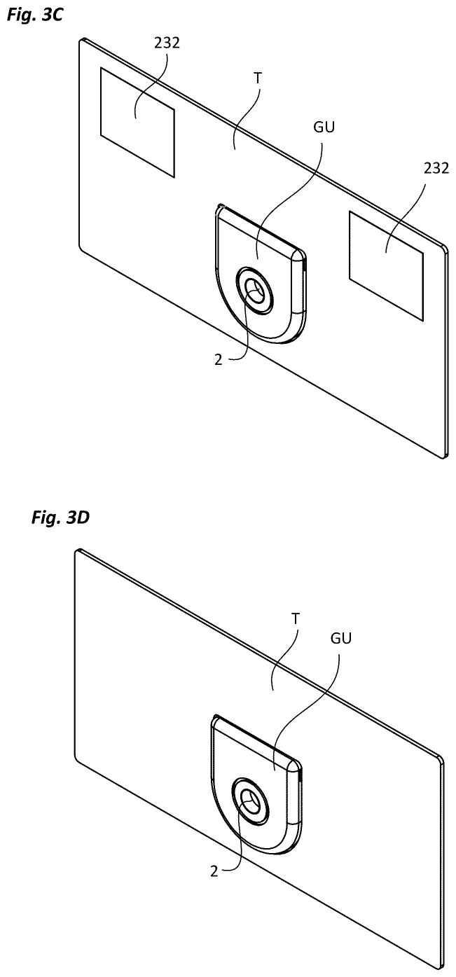

In a first solution shown in FIG. 3A, the second detection means 23 may be implemented in the form of one or more position sensors 230 integrated into at least one chock 40 in which a (front or rear) wheel of the vehicle V is intended to be positioned. Two chocks 40, each for a front wheel or for a rear wheel of the vehicle, may be positioned on either side of the second connection unit GU. At least one position sensor 230 is thus integrated into the chock in order to detect the presence of the wheel of the vehicle and thus determine the position of the vehicle with respect to the second connection unit GU.

In a second solution shown in FIG. 3B, the second detection means 23 may be implemented in the form of one or more position sensors 231 associated with at least one stop device 41 against which at least one wheel of the vehicle abuts when the vehicle is parked. Two stop devices 41, each for a front wheel or for a rear wheel of the vehicle, may be arranged on the mat T intended to be placed on the ground, on either side of the second connection unit GU. At least one position sensor 231 is thus integrated into the mat T in front of the stop device in order to detect the presence of the wheel of the vehicle and thus determine the position of the vehicle with respect to the second connection unit GU.

In a third solution shown in FIG. 3C, the second detection means 23 may be implemented in the form of one or more presence sensors 232, determining the presence of a vehicle close to the second connection unit. In this configuration, two presence sensors 232, one for each front or rear wheel of the vehicle V, are for example integrated into the mat T in which the second connection unit is integrated.

In a fourth solution shown in FIG. 3D, the second detection means 23 are integrated into the entire mat T in which the second connection unit is integrated. The second detection means 23 determine the presence of a vehicle close to the second connection unit GU. In this configuration, the position of the vehicle V is not known. The position of the vehicle is for example determined by taking into account the intensity of the magnetic field generated by the second connection unit GU and detected by the first detection means 13 of the first connection unit VU, located on the vehicle side. By virtue of these data collected by the first control unit UC_1, the user is able to be guided so as to position the vehicle and its first connection unit VU in a determined and suitable position with respect to that of the second connection unit GU.

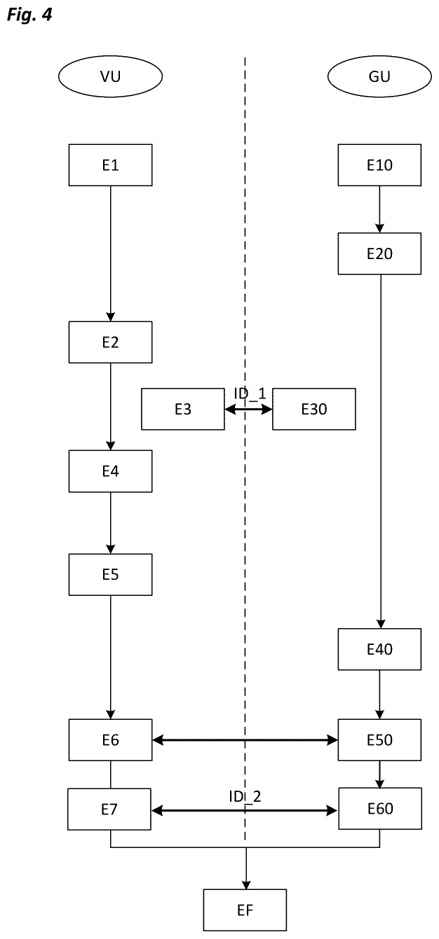

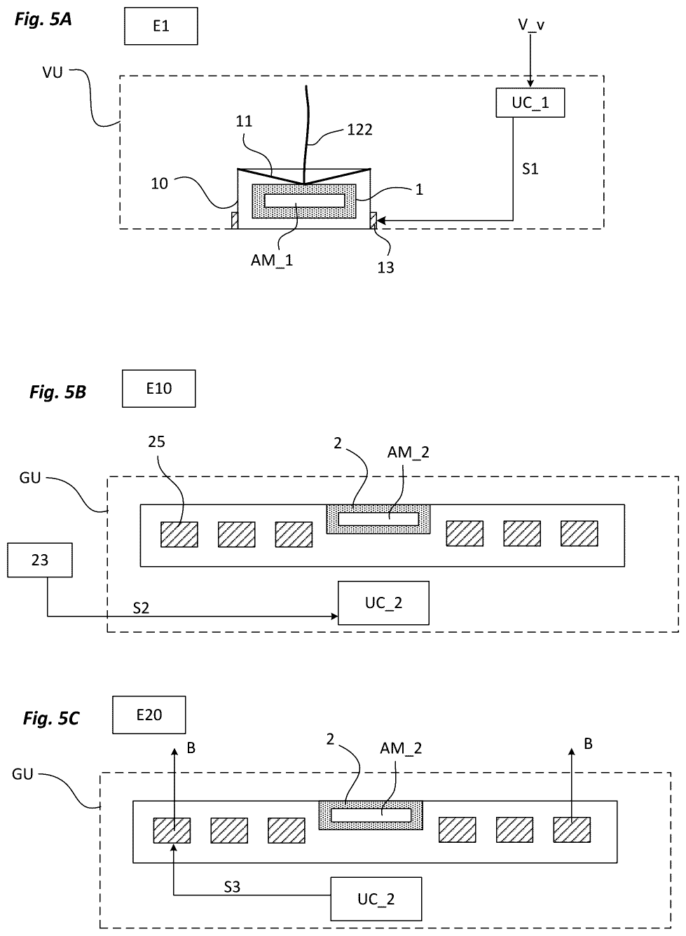

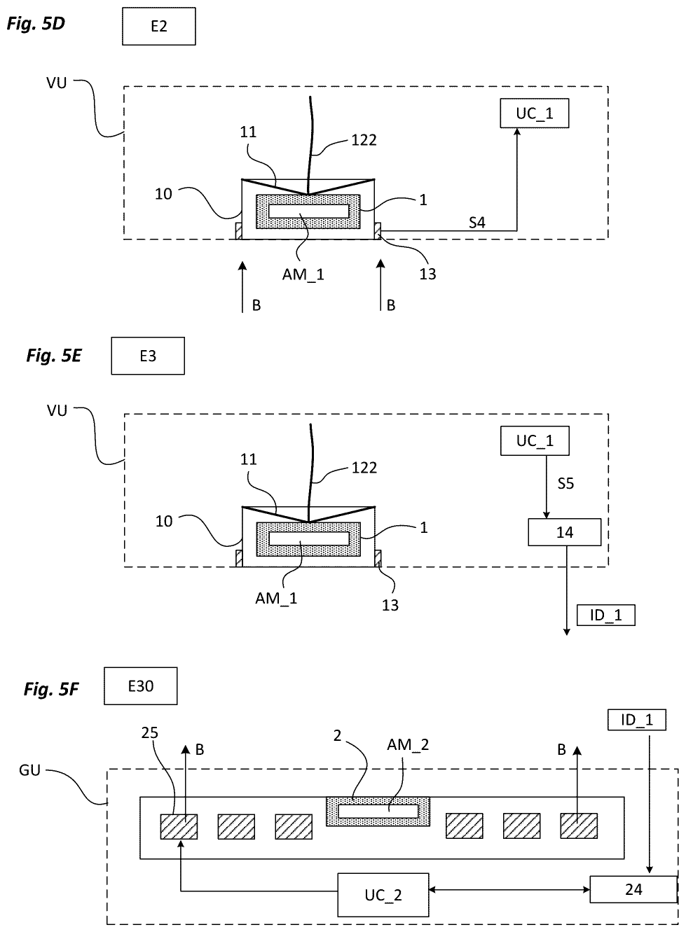

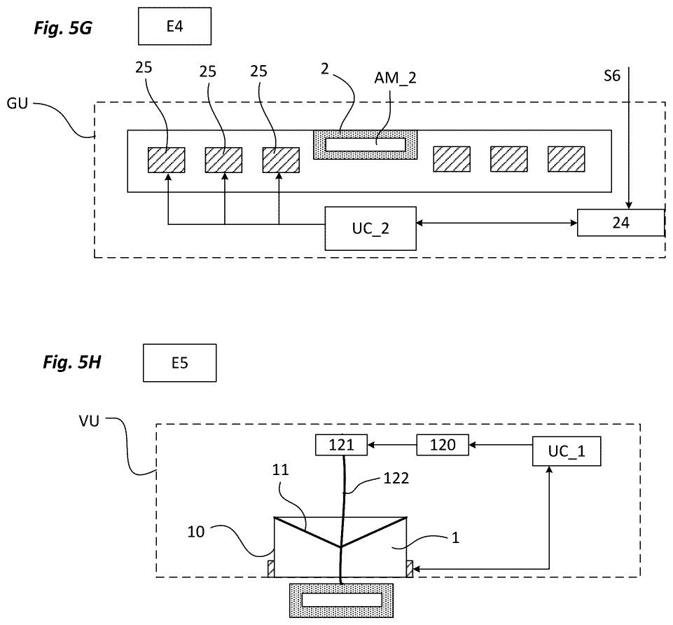

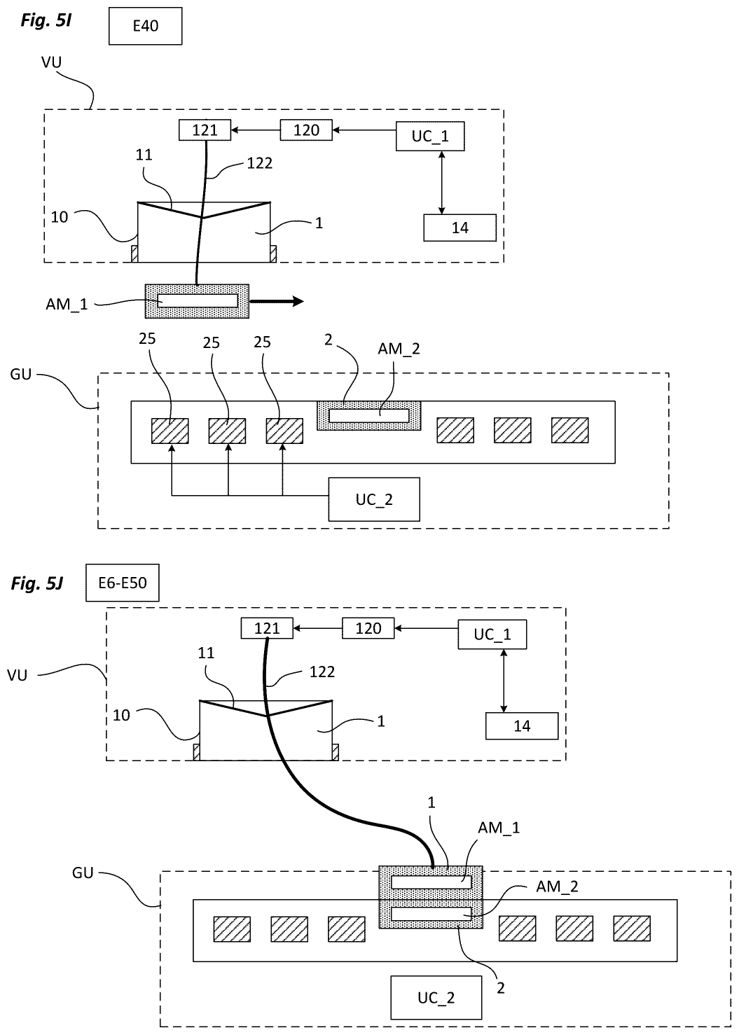

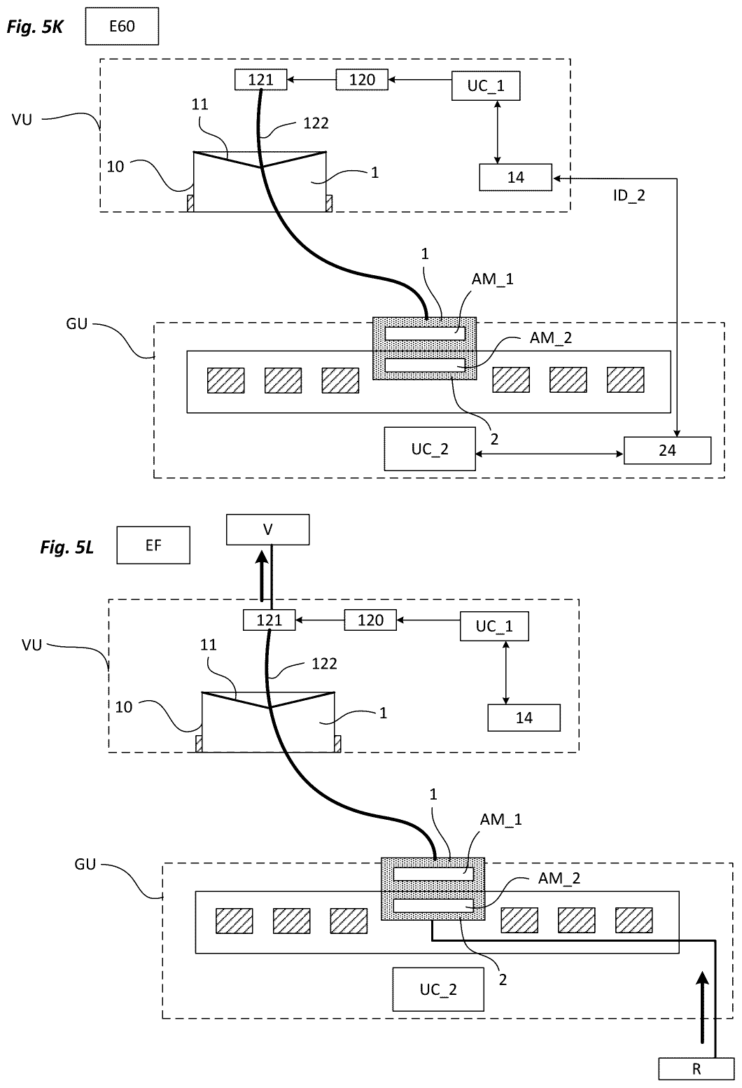

The operating principle of the system of the invention is described in more detail below, in connection with FIG. 4 and FIGS. 5A to 5L. It should be noted that some steps described below remain optional or could be implemented differently.

E1—FIG. 5A: The first control unit UC_1 detects, by virtue of its monitoring means (which are for example coupled to a speed sensor of the vehicle), the deceleration of the vehicle V and wakes up (signal S1) the first detection means 13 (for example Hall sensor) of the first connection unit VU when the speed V_v of the vehicle falls below a certain threshold.

E10—FIG. 5B: The second detection means 23 (position and/or presence sensor) associated with the second connection unit GU detect the presence and/or position of the vehicle V, and send a detection signal S2 to the second control unit UC_2 to wake up the second connection unit GU.

E20—FIG. 5C: Upon receipt of this detection signal, the second control unit UC_2 activates (control signal S3) for example at least one of the guide coils 25 of the second connection unit GU so as to generate a magnetic field B around the second connection unit GU.

E2—FIG. 5D: The first detection means 13 (for example Hall sensor), associated with the first connection unit VU, detect the presence of the magnetic field B and send a detection signal S4 to the first control unit UC_1. This step makes it possible to validate the correct positioning of the first connection unit VU with respect to the second connection unit GU. In other words, by detecting the presence of the magnetic field generated by the guide coil, the first connection unit VU knows that it is close to (in the field of) the second connection unit GU.

E3—FIG. 5E: The first control unit UC_1 executes a pre-authentication procedure. It activates its first communication means 14 (for example Bluetooth wireless link) (signal S5) so as to transmit identification data ID_1 to the second connection unit GU via its wireless communication interface.

E30—FIG. 5F: The second control unit UC_2 verifies the identification data ID_1 received via its wireless communication interface and determines whether the connection sequence is able to be triggered. This is the case for example when the second control unit UC_2 validates the mechanical and electrical compatibility between the socket 2 of the second connection unit GU and the plug 1 of the first connection unit VU.

It should be noted that the two steps E3 and E30, relating to the pre-authentication procedure, may be carried out at any time, as soon as the first connection unit VU and the second connection unit GU are within range of one another. This is of course made possible by the fact that the communication is carried out wirelessly.

E4—FIG. 5G: The connection sequence is triggered by the first control unit UC_1, which transmits a message (signal S6) to the second connection unit GU. This message may be sent automatically once both units VU, GU are operational in order to launch the connection sequence, or sent by the driver of the vehicle. The second control unit UC_2 launches the connection sequence by controlling the guide coils 25 in line with a pre-established control sequence.

E5—FIG. 5H: During the connection sequence, the first control unit UC_1 commands the release of the plug 1 from its storage housing 10, using the extraction means 11 and the release means (motor 120, winder 121 for example).

E40—FIG. 5I: The guidance sequence applied to the guide coils 25 at the second connection unit GU makes it possible to attract the plug 1 toward the socket 2, before making the connection between the two.

E6-E50—FIG. 5J: The mechanical and electrical connection is made between the plug 1 and the socket 2.

E60-E7—FIG. 5K: The second connection unit GU carries out an authentication procedure. The first connection unit VU and the second connection unit GU thus exchange for example identification data ID_2 via their wired communication interface.

EF—FIG. 5L: The first connection unit VU and the second connection unit GU are paired, and the plug 1 and the socket 2 are connected: Charging of the vehicle V is controlled by the second control unit UC_2.

It should be noted that the pre-authentication procedure and the authentication procedure may be of any type and correspond to exchanges of identification data, making it possible in particular to ensure mechanical and electrical compatibility between the two connection units VU, GU. They may also make it possible to determine the pricing of the charging and to launch billing for this charging.

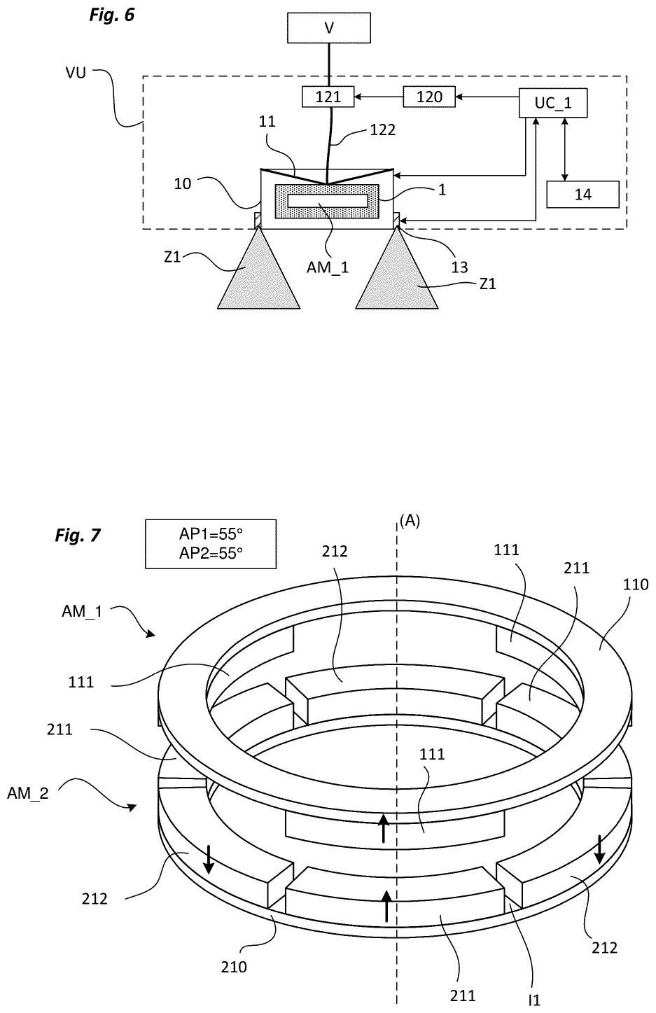

It should also be noted that, in the architecture of the first connection unit VU, the positioning of its first detection means 13 (for example Hall sensors positioned on the housing so as to skirt the plug) is designed such that they define a detection zone Z1 suitable for sensing only the presence of the magnetic field generated by the first connection unit during step E3 described above, and not the presence of the magnetic field created by its own magnetic architecture. FIG. 6 makes it possible to illustrate this particular feature of the invention.

One of the particular features of the invention is furthermore related to the fact that the second connection unit GU is made to use at least one of its guide coils 25 to generate the magnetic field B during step E3, able to be detected by the first connection unit VU. Once the first connection unit VU has detected the presence of this magnetic field B (and validated that it was in the field of the second connection unit GU) and after the pre-authentication, the second connection unit GU is advantageously made to disconnect this guide coil 25 in order to deactivate the magnetic field B, in order to avoid any magnetic disturbances and to allow it to then be able to start the connection sequence in step E8 defined above. The guide coil 25 will then be reactivated when the connection sequence is implemented.

It should be noted that the disconnection sequence is simpler because the two connection units already “know” one another. When the disconnection is commanded (at the end of charging or upon command of the driver), the second connection unit GU may trigger a sequence of disconnecting the plug 1. After electrical disconnection, the first connection unit VU commands the return of the plug 1 to its storage housing 10. As indicated above, the second connection unit GU may be able to launch a process of billing the charging service.

The invention thus has numerous advantages, including:
A complete solution for ensuring the automatic connection between the plug and the socket, without the intervention of an operator or robot;
A simple, safe, efficient and particularly compact solution.

1-18. (canceled)

19. A method for wired charging of a vehicle, said vehicle being one of a rechargeable electric vehicle and a rechargeable hybrid vehicle, said method comprising automatically making an electrical connection between a plug that is connected to an electrical power supply assembly of said vehicle and a socket that is connected to an electrical power supply network to which said electrical power supply assembly is to be connected in order to charge said vehicle, wherein said plug is initially housed in a housing of a first connection unit that is located on said vehicle, said first connection unit comprising a first control unit, wherein said socket is carried by a second connection unit, said second connection unit comprising a second control unit, wherein said plug and said socket comprise first and second magnetic architectures, respectively, thereby enabling said plug and socket to be magnetically coupled, wherein automatically making said electrical connection comprises: using an electromagnetic coil, causing said second connection unit to generate a magnetic field, using said first connection unit, detecting said magnetic field generated by said second connection unit, and upon having detected said magnetic field, automatically releasing said plug from said housing and launching an electrical connection sequence for magnetically attracting said plug toward said socket, wherein said electrical connection sequence comprises activating said electromagnetic coil to urge said plug to connect to said socket.

20. The method of claim 19, further comprising, prior to automatically making said connection, detecting a position of said vehicle with respect to said second connection unit and activating said second control unit when said vehicle has been determined to be in a stationary position.

21. The method of claim 19, further comprising, prior to automatically making said connection, detecting that said vehicle is present close to said second connection unit and guiding said vehicle so as to bring said vehicle into a determined position with respect to said second connection unit.

22. The method of claim 19, further comprising monitoring a speed of said vehicle, thereby obtaining a monitored speed, wherein detecting said magnetic field generated by said second connection unit is carried out based at least in part on said monitored speed.

23. The method of claim 19, further comprising, prior to launching said electrical connection sequence, carrying out a pre-authentication step between said first connection unit and said second connection unit, wherein said pre-authentication step comprises exchanging data via a wireless link between said connection units.

24. The method of claim 19, further comprising carrying out a pre-authentication step between said first connection unit and said second connection unit, wherein said pre-authentication step comprises exchanging data via a wired link between said first connection unit and said second connection unit when said plug is connected to said socket.

25. An apparatus comprising an automatic electrical connection system used for wired charging of vehicle selected from the group consisting of an electric vehicle and a hybrid vehicle, wherein said electrical connection system comprises a vehicle side and a network side, wherein said vehicle side comprises a plug connected to an electrical power supply assembly of said electric vehicle and a first connection unit, said first connection unit comprising a housing in which said plug is initially housed and a first control unit, wherein said network side comprises a socket connected to an electrical power supply network to which said power supply assembly of said electric vehicle has to be connected in order to charge said vehicle and a second connection unit, said second connection unit carrying said socket and comprising a second control unit, wherein said plug and said socket are configured to be magnetically coupled to each other, wherein said second connection unit comprises means for generating a magnetic field, wherein said second control unit is configured to activate said means for generating a magnetic field, wherein said first connection unit comprises a detector, wherein said detector is configured to detect a magnetic field generated by said second connection unit, wherein said first connection unit is configured to automatically release said plug from said housing in response to detection of a magnetic field, and wherein said second control unit is configured to activate an electrical connection sequence, said electrical connection sequence for magnetically attracting said plug toward said socket by activating said means for generating a magnetic field, thereby urging said plug to connect to said socket.

26. The apparatus of claim 25, wherein said detector is a first detector and wherein said system comprises a second detector, wherein said second detector is configured for detecting presence of said vehicle when said vehicle is within a predetermined distance of said second connection unit and wherein said system comprises a guidance system for guiding said vehicle to a predetermined position with respect to said second connection unit.

27. The apparatus of claim 25, further comprising a monitor obtaining a monitored speed of said vehicle and wherein said first control unit is configured to activate said detector based at least in part on said monitored speed.

28. The apparatus of claim 25, wherein said first control unit and said second control unit are configured to execute a pre-authentication sequence between said first connection unit and said second connection unit by exchanging identification data via a wireless link between said two connection units prior to forming an electrical connection between said plug and said socket.

29. The apparatus of claim 25, wherein said first control unit and said second control unit are configured to execute an authentication sequence between said first connection unit and said second connection unit by exchanging identification data via a wired link between said two connection units once said plug has been connected to said socket.

30. The apparatus of claim 25, wherein said electrical connection sequence is configured to activate said means for generating a magnetic field to magnetically attract said plug toward said socket.

31. The apparatus of claim 25, wherein means for generating said magnetic field comprises an electromagnetic coil and wherein said second control unit is configured to activate said electromagnetic coil to generate said magnetic field.

32. The apparatus of claim 25, wherein said detector is arranged in said first connection unit to detect presence of said magnetic field generated by said second connection unit and to discriminate said magnetic field from a second magnetic field, said second magnetic field being generated by said first magnetic architecture.

33. The apparatus of claim 25, wherein said detector is a first detector and said system comprises a second detector, wherein said second detector is configured to detect a position of said vehicle relative to said second connection unit and wherein said system further comprises activation means for activating said second connection unit when said vehicle is in a determined stationary position.

34. The apparatus of claim 25, wherein said detector is a first detector and said system comprises a mat and a second detector integrated into said mat, wherein said second detector is configured to detect a position of said vehicle relative to said second connection unit, and wherein said second connection unit is integrated into said mat.

35. The apparatus of claim 25, wherein said detector is a first detector and said system comprises a mat, a second detector integrated into said mat, and at least one chock fixed to said mat, wherein said second detector comprises a position sensor that is integrated into said chock.

36. The apparatus of claim 25, wherein said detector is a first detector and said system comprises a mat, a second detector integrated into said mat, and at least one stop device fixed to said mat, wherein said second detector comprises a position sensor integrated into said mat at a predetermined distance from said stop device.
